(19) United States
(12) Patent Application Publication
(10) Pub. No.: US 2025/0115811 A1
(43) Pub. Date: Apr. 10, 2025

(54) COMPOSITION AND METHOD FOR ABATING FOULING BY LOW-DENSITY INORGANIC, ORGANIC AND INORGANIC-ORGANIC HYBRID FOULANTS IN HYDROCARBON PROCESSES

(71) Applicant: ECOLAB USA Inc., St. Paul, MN (US)

(72) Inventors: Jonathan MASERE, Richmond, TX (US); Abuzar SYED, Richmond, TX (US); Ashish DHAWAN, Aurora, IL (US)

(73) Assignee: ECOLAB USA Inc., St. Paul, MN (US)

(21) Appl. No.: 18/894,525

(22) Filed: Sep. 24, 2024

Related U.S. Application Data
(60) Provisional application No. 63/588,108, filed on Oct. 5, 2023.

(51) Int. Cl. C09K 23/36; C09K 23/12; C09K 23/22; C10L 3/10

(52) U.S. Cl. CPC C09K 23/36; C09K 23/12; C09K 23/22; C10L 3/10; C10L 2230/08

(57) ABSTRACT

The disclosure provides compositions and methods for reducing fouling of a surface in contact with a medium during a natural gas processing procedure. Methods may include adding a composition to the medium, wherein the medium includes an inorganic particle, an organic particle, and/or an inorganic-organic particle, and the composition includes a surfactant. The surfactant may encapsulate the particle. The surfactant may include, for example, a phthalate ester, a naphthalate ester, a tall oil fatty acid, a soya oil fatty acid, sunflower oil fatty acid, canola oil fatty acid, coconut oil fatty acid, cyrene, a trigylceride, or any combination thereof.

### TECHNICAL FIELD

The present disclosure generally relates to methods and compositions for inhibiting fouling. More particularly, the disclosure relates to methods of inhibiting fouling during hydrocarbon processing operations using a composition that comprises a surfactant.

### BACKGROUND

Fouling caused by the deposition of inorganic material is a long-standing and costly challenge in the processing of raw natural gas. Water, liquid hydrocarbon, insoluble hydrocarbon solids, and insoluble inorganic salts are swept up along with the gathered natural gas. These various phases are separated in an inlet separator vessel (ISV) in which the gas flows from the ISV overhead to the compressor station. The aqueous layer and the high-density solids settle to the bottom of the ISV from which they are drained off for disposal. Because of its economic value, the hydrocarbon condensate stream flows to the condensate stabilizer section for distillative purification. The stream is contaminated with hydrophobic and lipophobic low-density inorganic solids that partition into hydrocarbon media instead of the aqueous layer. Mixed oxidation state iron sulfides, magnetite, and iron (II) carbonate are typical examples. The low-density solids are entrained with the hydrocarbon condensate as suspensions.

The condensate stream has an average boiling point of about 60° C. On evaporation of the liquid in the reboiler, at around 109° C., the entrained inorganic solids are deposited onto the surface of the reboiler with an insufficient wetting liquid medium to keep the solids flowable and easily disposable online. As a result, this leads to the rapid and severe fouling, poor performance, increased energy consumption and, ultimately, frequent shutdowns for the mechanical cleaning of the reboilers.

### BRIEF SUMMARY

The present disclosure provides compositions and methods for inhibiting fouling in hydrocarbon processing operations. In some embodiments, the present disclosure provides a method of reducing fouling of a surface in contact with a medium during a natural gas processing procedure. The method comprises adding a composition to the medium. The medium may comprise an inorganic particle, an organic particle, and/or an inorganic-organic particle. The composition comprises a surfactant. The method also includes encapsulating the particle.

The foregoing has outlined rather broadly the features and technical advantages of the present disclosure in order that the detailed description that follows may be better understood. Additional features and advantages of the disclosure will be described hereinafter that form the subject of the claims of this application.

### BRIEF DESCRIPTION OF THE SEVERAL VIEWS OF THE DRAWINGS

A detailed description of the invention is hereafter described with specific reference being made to the drawings in which:

FIG. 1 shows the encapsulation and phase inversion of inorganic particulates leading to the cleaning of the hydrocarbon condensate; and

FIG. 2 shows a schematic diagram depicting the flow of the streams/mediums, particularly the stream/medium leading to the condensate stabilizer unit.

### DETAILED DESCRIPTION

Various embodiments are described below with reference to the drawings in which like elements generally are referred to by like numerals. The relationship and functioning of the various elements of the embodiments may better be understood by reference to the following detailed description. However, embodiments are not strictly limited to those illustrated in the drawings or described below.

Examples of methods and materials are described below, although methods and materials similar or equivalent to those described herein can be used in practice or testing of the present disclosure. All publications, patent applications, patents and other reference materials mentioned herein are incorporated by reference in their entirety. The materials, methods, and examples disclosed herein are illustrative only and not intended to be limiting.

Unless otherwise defined, all technical and scientific terms used herein have the same meaning as commonly understood by one of ordinary skill in the art. In case of conflict, the present document, including definitions, will control.

Unless otherwise indicated, an alkyl group as described herein alone or as part of another group is an optionally substituted linear or branched saturated monovalent hydrocarbon substituent. Examples of unsubstituted alkyl groups include methyl, ethyl, n-propyl, i-propyl, n-butyl, i-butyl, s-butyl, t-butyl, n-pentyl, i-pentyl, s-pentyl, t-pentyl, and the like.

The terms “aryl” or “ar” as used herein alone or as part of another group (e.g., arylene) denote optionally substituted homocyclic aromatic groups, such as monocyclic or bicyclic groups containing from about 6 to about 12 carbons in the ring portion, such as phenyl, biphenyl, naphthyl, substituted phenyl, substituted biphenyl or substituted naphthyl. The term “aryl” also includes heteroaryl functional groups. It is understood that the term “aryl” applies to cyclic substituents that are planar and comprise 4n+2 electrons, according to Huckel's Rule.

“Cycloalkyl” refers to a cyclic alkyl substituent containing from, for example, about 3 to about 8 carbon atoms, preferably from about 4 to about 7 carbon atoms, and more preferably from about 4 to about 6 carbon atoms. Examples of such substituents include cyclopropyl, cyclobutyl, cyclopentyl, cyclohexyl, cycloheptyl, cyclooctyl, and the like. The cyclic alkyl groups may be unsubstituted or further substituted with alkyl groups, such as methyl groups, ethyl groups, and the like.

Compounds of the present disclosure may be substituted with suitable substituents. The term “suitable substituent,” as used herein, is intended to mean a chemically acceptable functional group, preferably a moiety that does not negate the activity of the compounds. Such suitable substituents include, but are not limited to, halo groups, perfluoroalkyl groups, perfluoro-alkoxy groups, alkyl groups, alkenyl groups, alkynyl groups, hydroxy groups, oxo groups, mercapto groups, alkylthio groups, alkoxy groups, aryl or heteroaryl groups, aryloxy or heteroaryloxy groups, aralkyl or heteroaralkyl groups, aralkoxy or heteroaralkoxy groups, HO—(C═O)— groups, heterocylic groups, cycloalkyl groups, amino groups, alkyl-and dialkylamino groups, carbamoyl groups, alkylcarbonyl groups, alkoxycarbonyl groups, alkylaminocarbonyl groups, dialkylamino carbonyl groups, arylcarbonyl groups, aryloxy-carbonyl groups, alkylsulfonyl groups, and arylsulfonyl groups. In some embodiments, suitable substituents may include halogen, an unsubstituted C₁-C₁₂ alkyl group, an unsubstituted C₄-C₆ aryl group, or an unsubstituted C₁-C₁₀ alkoxy group. Those skilled in the art will appreciate that many substituents can be substituted by additional substituents.

The term “substituted” as in “substituted alkyl,” means that in the group in question (e.g., the alkyl group), at least one hydrogen atom bound to a carbon atom is replaced with one or more substituent groups, such as hydroxy (—OH), alkylthio, phosphino, amido (—CON(R_{A})(R_{B}), wherein R_{A} and R_{B} are independently hydrogen, alkyl, or aryl), amino (—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like.

When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

The terms “polymer,” “copolymer,” “polymerize,” “copolymerize,” and the like include not only polymers comprising two monomer residues and polymerization of two different monomers together, but also include (co)polymers comprising more than two monomer residues and polymerizing together more than two or more other monomers. For example, a polymer as disclosed herein includes a terpolymer, a tetrapolymer, polymers comprising more than four different monomers, as well as polymers comprising, consisting of, or consisting essentially of two different monomer residues. Additionally, a “polymer” as disclosed herein may also include a homopolymer, which is a polymer comprising a single type of monomer unit.

Unless specified differently, the polymers of the present disclosure may be linear, branched, crosslinked, structured, synthetic, semi-synthetic, natural, and/or functionally modified. A polymer of the present disclosure can be in the form of a solution, a dry powder, a liquid, or a dispersion, for example.

The present disclosure provides a lipophilic composition with a high boiling point useful for abating/inhibiting fouling. As described herein, the composition may comprise one or more components and/or compounds and each component and/or compound may comprise a high boiling point, as further defined below. The compositions disclosed herein have been surprisingly found to be effective in dispersing, phase-inverting, and/or wetting the inorganic, organic, and/or inorganic-organic solids that cause fouling. The composition disclosed herein may be used in an online cleaning process of the foulant material.

In some embodiments, the compositions and methods disclosed herein increase reboiler runlength and economize operations by inhibiting fouling of, for example, a condensate stabilizer reboiler. As is more fully described below, the fouling may be caused by, for example, hydrocarbon-entrained low-density inorganic solids.

The compositions disclosed herein comprise a surfactant and the surfactant may encapsulate the solids/foulants. The surfactant may comprise, for example, a phthalate ester, a naphthalate ester, a tall oil fatty acid, a soya oil fatty acid, sunflower oil fatty acid, canola oil fatty acid, coconut oil fatty acid, avocado oil fatty acid, corn oil fatty acid, cottonseed oil fatty acid, grape seed oil fatty acid, hazelnut oil fatty acid, hemp seed oil fatty acid, linseed oil fatty acid, olive oil fatty acid, palm kernel oil fatty acid, peanut seed oil fatty acid, rape seed oil fatty acid, rice bran oil fatty acid, safflower oil fatty acid, sesame oil fatty acid, walnut oil fatty acid, cyrene, a trigylceride, and any combination thereof.

As illustrative, non-limiting examples, the phthalate ester may comprise monomethyl phthalate, monoethyl phthalate, monononyl phthalate, monododecyl phthalate, monoundecyl phthalate, dimethyl phthalate, diethyl phthalate, dinonyl phthalate, didodecyl phthalate, diundecyl phthalate, monophenyl phthalate, monobenzyl phthalate, diphenyl phthalate, dibenzyl phthalate, or a combination thereof.

The surfactant may be, for example, a cationic surfactant, an anionic surfactant, or an amphoteric surfactant. In some embodiments, the surfactant is an anionic surfactant or an amphoteric surfactant having an overall anionic charge.

The compositions disclosed herein may comprise additional compounds and/or components. For example, a composition may further comprise a dispersant. The dispersant may optionally be an amide, imide, ester, or acid reaction product of an alkenylsuccinic anhydride (ASA) with a pendant hydrocarbon and an amine having at least one primary amine group, an alcohol, or water. Illustrative, non-limiting examples of reaction products are as follows:

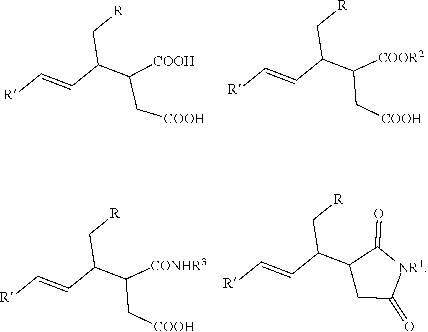

Various synthetic routes known to those skilled in the art may be utilized to prepare the reaction products. Illustrative, non-limiting examples are as follows:

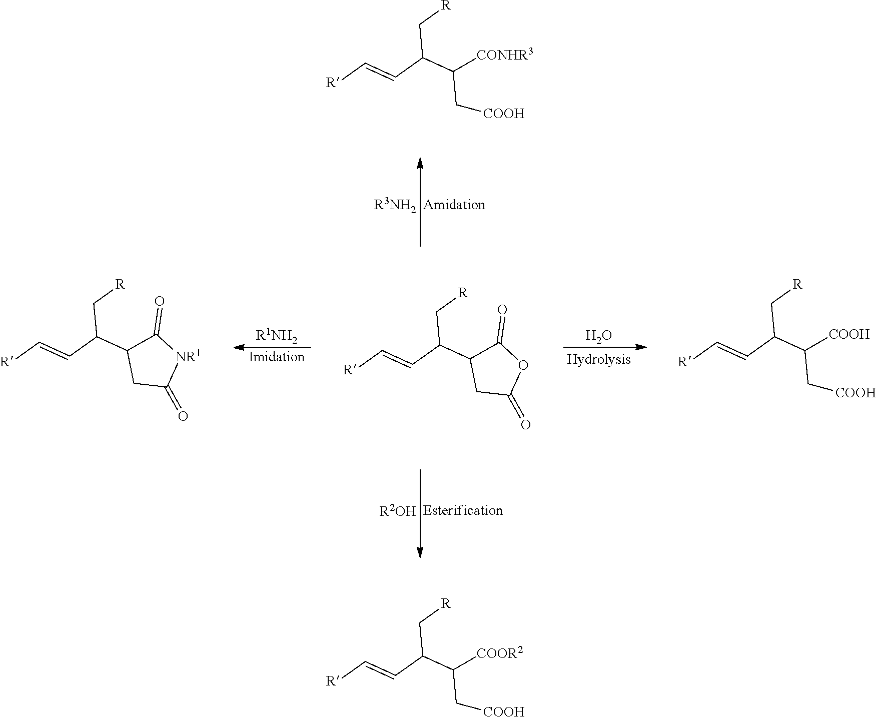

The pendant hydrocarbon may be selected from, for example, an alkyl group, an aryl group, an aryl alkyl group, an alkyl aryl group, an alkenyl group, an alkenyl aryl group, and an aryl alkenyl group. Each of the foregoing groups may comprise, for example, from about 6 to about 50 carbon atoms, such as from about 6 to about 40, about 6 to about 30, about 6 to about 20, about 6 to about 10, about 10 to about 50, about 20 to about 50, about 30 to about 50, about 7 to about 25, or about 8 to about 15.

In some embodiments, the reaction product comprises a monoamide, a diamide, a triamide, an imide, an ester, or any combination thereof.

The weight average molecular weight of the amide reaction product is not particularly limited. As an illustrative, non-limiting example, the amide reaction product has a weight average molecular weight ranging from about 400 Da to about 2,000 Da. For example, the molecular weight may be from about 400 Da to about 1,750 Da, about 400 Da to about 1,500 Da, about 400 Da to about 1,250 Da, about 400 Da to about 1,000 Da, about 400 Da to about 750 Da, about 750 Da to about 2,000 Da, about 1,000 Da to about 2,000 Da, about 1,250 Da to about 2,000 Da, about 1,500 Da to about 2,000 Da, or about 1,750 Da to about 2,000 Da.

Any component and/or compound of the composition disclosed herein may have a boiling point greater than about 50° C., such as from about 50° C. to about 285° C., about 60° C. to about 285° C., about 70° C. to about 285° C., about 80° C. to about 285° C., about 90° C. to about 285° C., about 100° C. to about 285° C., about 115° C. to about 285° C., about 130° C. to about 285° C., about 150° C. to about 285° C., about 175° C. to about 285° C., about 60° C. to about 85° C., about 75° C. to about 100° C., about 85° C. to about 115° C., about 80° C. to about 180° C., or about 65° C. to about 265° C.

The composition disclosed herein may comprise various amounts of the surfactant and optional additional compounds and/or components. For example, the composition may comprise from about 5 wt. % of the surfactant to about 100 wt. % of the surfactant. In illustrative, non-limiting embodiments, the composition may comprise from about 15 wt. % to about 100 wt. %, about 25 wt. % to about 100 wt. %, about 35 wt. % to about 100 wt. %, about 45 wt. % to about 100 wt. %, about 55 wt. % to about 100 wt. %, about 65 wt. % to about 100 wt. %, about 75 wt. % to about 100 wt. %, about 85 wt. % to about 100 wt. %, about 90 wt. % to about 100 wt. %, about 95 wt. % to about 100 wt. %, about 20 wt. % to about 80 wt. %, about 30 wt. % to about 90 wt. %, about 40 wt. % to about 85 wt. %, or about 60 wt. % to about 90 wt. % of the surfactant.

The composition may comprise from about 1 wt. % of the optional additional compounds and/or components to about 80 wt. % of the optional additional compounds and/or components. In illustrative, non-limiting embodiments, the composition may comprise from about 1 wt. % to about 70 wt. %, about 1 wt. % to about 60 wt. %, about 1 wt. % to about 50 wt. %, about 1 wt. % to about 40 wt. %, about 1 wt. % to about 30 wt. %, about 1 wt. % to about 20 wt. %, about 1 wt. % to about 10 wt. %, or about 1 wt. % to about 5 wt. % of the optional additional compounds and/or components.

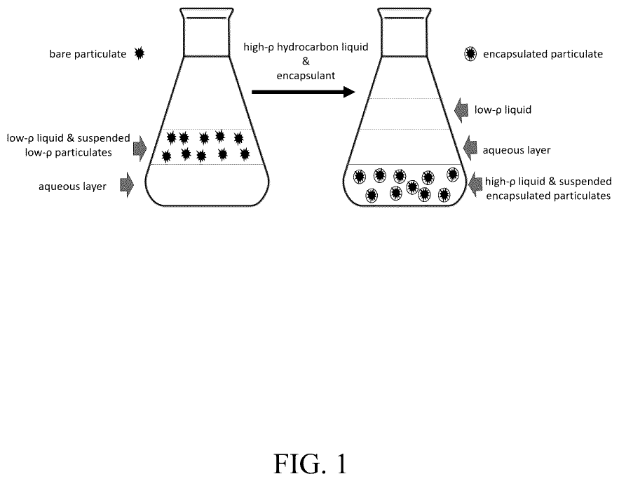

As can be seen in FIG. 1, to mitigate/inhibit fouling caused by the hydrocarbon-suspended and low-density hydrophobic inorganic particles, organic particles, and/or particles comprising both inorganic and organic components (inorganic-organic hybrid particles), the composition disclosed herein may encapsulate the particles using the surfactants disclosed herein as encapsulants. On encapsulation, the lipophilicity of the particle is increased as the polar heads of the surfactant are attached to the surface of the particle, thereby leaving the lipophilic hydrocarbon tails jutting out away from the surface of the particle. The inclusion of a hydrocarbon with a density higher than that of water and the low-density hydrocarbon typical of natural gas condensate results in the encapsulated particulates partitioning into and suspension in the high-density hydrocarbon.

The composition disclosed herein may also serve the additional function of an antidesiccant, which therefore prevents fouling of surfaces, such as those found on a condensate stabilizer reboiler. In the reboiler of a distillation column, the average skin temperature is around 109° C., which is high enough to boil off most of the condensate hydrocarbon, which boils at an average temperature of about 59° C. The evaporation of the liquid results in the formation of dry and heat compacted deposits of the entrained particles. To prevent the deposits from drying up and forming compact deposits, the disclosed technology serves as a washing or antidesiccant composition with a boiling point as disclosed herein.

Also, the surfactants disclosed herein, such as the naphthalate esters, have densities that are higher than the typical foulants in the reboiler deposits. In the reboiler, the naphthalate ester liquids keep the surface wet to render the deposits flowable and disposable through the blowdown.

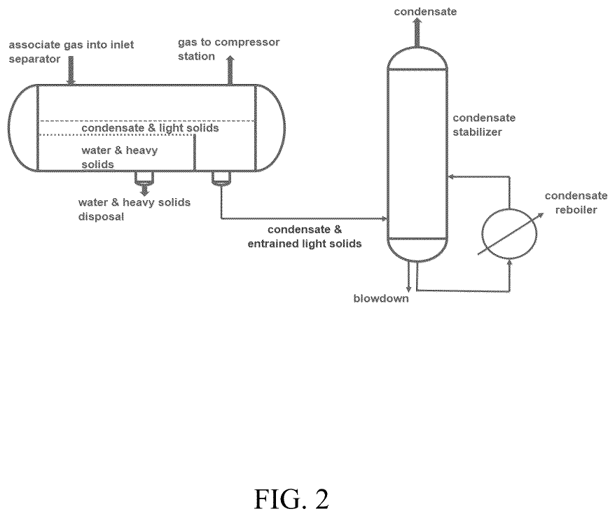

As can be seen in FIG. 2, in a typical method for processing natural gas, a stream enters an ISV and that stream may comprise, for example, water, liquid hydrocarbon, insoluble hydrocarbon solids, such as an asphaltene, a coke solid, a gum, or any combination thereof, and insoluble inorganic salts. These various phases are separated in the ISV and the gas flows from the ISV overhead to the compressor station. The aqueous layer and the high-density solids settle to the bottom of the ISV from which they are drained off for disposal. The hydrocarbon condensate stream flows to the condensate stabilizer section for distillative purification, which may optionally be carried out by heating the medium to between about 100° C. and 115° C.

However, the stream is contaminated with hydrophobic and lipophobic low-density inorganic solids that partition into hydrocarbon media instead of the aqueous layer. The low-density solids are entrained with the hydrocarbon condensate as suspensions. The condensate is distilled off, thereby leaving the suspended solids as residue deposited on a surface, such as a surface of the reboiler.

To counter this unwanted fouling, the present disclosure provides methods of reducing fouling of a surface in contact with a medium during a natural gas processing procedure. The methods include adding a composition disclosed herein to the medium and/or the surface. The medium comprises the inorganic, organic, and/or inorganic-organic particle and certain components of the composition encapsulate the particle.

The composition may be added to the medium and/or surface continuously or intermittently. The composition may be added in an amount effective to inhibit fouling, such as from about 1 ppm to about 50,000 ppm, about 1 ppm to about 25,000 ppm, about 1 ppm to about 15,000 ppm, about 1 ppm to about 5,000 ppm, about 1 ppm to about 1,000 ppm, about 1 ppm to about 500 ppm, about 1 ppm to about 250 ppm, about 1 ppm to about 100 ppm, about 50 ppm to about 50,000 ppm, about 100 ppm to about 50,000 ppm, about 500 ppm to about 50,000 ppm, about 1,000 ppm to about 50,000 ppm, about 10,000 ppm to about 50,000 ppm, about 20,000 ppm to about 50,000 ppm, about 30,000 ppm to about 50,000 ppm, about 40,000 ppm to about 50,000 ppm, about 100 ppm to about 2,000 ppm, or about 50 ppm to about 1,000 ppm.

The composition may be added at any point or location in the process. For example, the composition may be added before an ISV and/or after an ISV, before and/or after a condensate stabilizer unit, before a condensate reboiler, or any combination thereof.

The medium may comprise natural gas and it may optionally comprise additional components, such as one or more of water, liquid hydrocarbon, insoluble hydrocarbon solids, insoluble inorganic salts, insoluble particles comprising both inorganic and organic components (i.e., inorganic-organic hybrid particles), etc.

The inorganic salt foulants/particulates/particles may comprise, for example, iron sulfide (Greigite—Fe₃S₄), iron carbonate (Siderite—FeCO₃), iron oxide (magnetite—Fe₃O₄), or any combination thereof.

It was discovered that these inorganic compounds were hydrophobic, unlike iron (II) sulfide, which partitions into water. In addition to the hydrophobic character of the foulants, it was also discovered that they had densities lower than that of water. As a result of the low density, the solids may partition into the hydrocarbon. When not agitated, the solids may settle at the interface of the hydrocarbon liquid and the aqueous layer. When operations are online, the flow of the process stream results in constant agitation such that the low-density inorganic compounds are suspended in the hydrocarbon condensate.

The foregoing may be better understood by reference to the following examples, which are intended for illustrative purposes and are not intended to limit the scope of the disclosure or its application in any way.

### EXAMPLES

### Example 1. Evaporative Solvent Loss and Flowability

A sample of the dry deposit collected from a fouled reboiler was ground into a fine powder. Into each of three 100-ml beakers, about 0.500 g were charged. Into one beaker, 50 mL of n-hexane were added followed by stirring the mixture into a homogenous slurry. Slurries comprising heavy aromatic naphtha and dimethyl phthalate were prepared using the aforementioned method. The three slurries were placed in a heat bath armed with airflow heads through which air was used to sweep the headspace. To mimic the reboiler temperature, the heat bath temperature was set at 109° C. The slurries were incubated at this temperature and purged with air for an hour after which the slurries were cooled.

With n-hexane as the slurry solvent, the loss was 100%, leading to a dry deposit at the bottom of the beaker. The volume of heavy aromatic lost was 40 mL, amounting to a loss of 80%. Though there was a loss in the solvent during this static test, the slurry remained wet. In the slurry prepared with dimethyl phthalate, the solvent loss during the high-temperature incubation and air purge was 0%.

The procedure above was used to determine the solvent loss using prototypes of glycols, cyrene, tall oil fatty acid (TOFA), and triglycerides. With exception of butyl glycol, which had a loss of 70%, the rest of the prototypes had no loss.

### Example 2. Neat Solvent Dispersancy Tests

A test was carried out to determine the dispersancy capacity of four solvent prototypes. The tested solvents were heavy aromatic naphtha, dimethyl phthalate, TOFA, and vegetable-oil triglyceride. These four solvents, with the exception of heavy aromatic naphtha, had excellent high boiling points as shown in Example 1. A field sample collected from a fouled reboiler was ground into a fine powder. Into each of five tubes, 20 mg were added. To the tubes were added 10 mL of neat solvents. The tubes were capped and agitated to disperse the powdered deposit. Immediately thereafter, the tubes were placed in a rack and the rate of the sedimentation of the suspended foulant particulates tracked as a function of time.

According to the test, dimethyl phthalate, TOFA, and vegetable-oil triglyceride displayed surprisingly excellent dispersancy efficacies. Where the suspension of the foulant took less than 10 seconds to completely sediment in heavy aromatic naphtha, sedimentation in dimethyl phthalate, TOFA, and vegetable-oil triglyceride was not complete even after 1 hour. Thus, in addition to the low volatility of these three solvents, they also exhibited highly desirable dispersancy of the foulant particulates.

### Example 3. Dimethyl Phthalate and Dispersants

Fours dispersants were used in tests in which dimethyl phthalate (DMP) was used as the medium. Each of five test tubes was charged with 20 mg of pulverized deposit material. To each was then added 10 mL of DMP. The first tube was treated to give 100 ppm of dispersant 1, which was a polynaphthalene sulfonate. In the second test tube, the solution was dosed with dispersant 2, which was a polystyrene sulfonate, to give 100 pm of dispersant. About 100 ppm of dispersant 3, was a polycarboxylate, was dosed in the third tube. The fourth tube was treated with dispersant 4, which was a poly (alkenyl succinamide), thereby resulting in 100 ppm of the dispersant. The fifth tube was left untreated. All the contents were vigorously stirred until the foulant material was in suspension after which the tubes were placed in a rack to monitor the rate at which the suspended solids settled to the bottom of the test tube. As the suspended solids settled to the bottom, montages were captured at regular time intervals.

According to the tests, of the four dispersants, only dispersant 4 performed poorly compared to the untreated sample. Dispersants 1-3 were found to be effective.

### Example 4. Weighting Agents to Remove Low-Density Foulants

Portions of the field-sample hydrocarbon liquid containing suspended inorganic solids were used in tests to remove the suspended solids from the hydrocarbon phase. In one scintillation vial, 10 mL of deionized water was mixed with 5 mL of the field hydrocarbon. In the second vial, 10 mL of deionized water, 5 mL of the field hydrocarbon and 2 mL of oleic acid as the encapsulant were added. In the third vial, deionized water, the field hydrocarbon and 2 mL of DMP as the weighting agent were charged. In the fourth vial were added deionized water, the field hydrocarbon, oleic acid and the weighting agent.

After capping the vials, the vials were vigorously shaken after which the mixtures were set aside to settle. In the first vial, the low-density solids were initially suspended in the hydrocarbon. After a few minutes, the solids settled on the water-hydrocarbon interface. In the second vial, the same phenomenon was observed. The third vial, which included the hydrocarbon, deionized water and the weighting agent, DMP, three liquid phases were observed following the settling of the agitated mixture. DMP settled at the bottom of the vial. Surprisingly, the DMP pulled to the bottom layer some of the solids previously suspended in the low-density field hydrocarbon. However, some of the solids settled at the interface of the water layer and the low-density hydrocarbon. In the vial with a mixture that included the weighting agent and the encapsulant, more of the low-density solids were partitioned into the high-density DMP hydrocarbon liquid.

All of the compositions and methods disclosed and claimed herein can be made and executed without undue experimentation in light of the present disclosure. While this invention may be embodied in many different forms, there are described in detail herein specific preferred embodiments of the invention. The present disclosure is an exemplification of the principles of the invention and is not intended to limit the invention to the particular embodiments illustrated. In addition, unless expressly stated to the contrary, use of the term “a” is intended to include “at least one” or “one or more.” For example, “a device” is intended to include “at least one device” or “one or more devices.”

Any ranges given either in absolute terms or in approximate terms are intended to encompass both, and any definitions used herein are intended to be clarifying and not limiting. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges (including all fractional and whole values) subsumed therein.

Any composition disclosed herein may comprise, consist of, or consist essentially of any element, component and/or ingredient disclosed herein or any combination of two or more of the elements, components or ingredients disclosed herein.

Any method disclosed herein may comprise, consist of, or consist essentially of any method step disclosed herein or any combination of two or more of the method steps disclosed herein.

The transitional phrase “comprising,” which is synonymous with “including,” “containing,” or “characterized by,” is inclusive or open-ended and does not exclude additional, un-recited elements, components, ingredients and/or method steps.

The transitional phrase “consisting of” excludes any element, component, ingredient, and/or method step not specified in the claim.

The transitional phrase “consisting essentially of” limits the scope of a claim to the specified elements, components, ingredients and/or steps, as well as those that do not materially affect the basic and novel characteristic(s) of the claimed invention.

Unless specified otherwise, all molecular weights referred to herein are weight average molecular weights and all viscosities were measured at 25° C. with neat (not diluted) polymers.

As used herein, the term “about” refers to the cited value being within the errors arising from the standard deviation found in their respective testing measurements, and if those errors cannot be determined, then “about” may refer to, for example, within 5%, 4%, 3%, 2%, or 1% of the cited value.

Furthermore, the invention encompasses any and all possible combinations of some or all of the various embodiments described herein. It should also be understood that various changes and modifications to the presently preferred embodiments described herein will be apparent to those skilled in the art. Such changes and modifications can be made without departing from the spirit and scope of the invention and without diminishing its intended advantages. It is therefore intended that such changes and modifications be covered by the appended claims.

What is claimed is:

1. A method of reducing fouling of a surface in contact with a medium during a natural gas processing procedure, comprising:
adding a composition to the medium, wherein the medium comprises an inorganic particle, an organic particle, and/or an inorganic-organic particle, and the composition comprises a surfactant; and
encapsulating the particle.

2. The method of claim 1, wherein the surfactant comprises a phthalate ester, a naphthalate ester, a tall oil fatty acid, a soya oil fatty acid, sunflower oil fatty acid, canola oil fatty acid, coconut oil fatty acid, avocado oil fatty acid, corn oil fatty acid, cottonseed oil fatty acid, grape seed oil fatty acid, hazelnut oil fatty acid, hemp seed oil fatty acid, linseed oil fatty acid, olive oil fatty acid, palm kernel oil fatty acid, peanut seed oil fatty acid, rape seed oil fatty acid, rice bran oil fatty acid, safflower oil fatty acid, sesame oil fatty acid, walnut oil fatty acid, cyrene, a trigylceride, and any combination thereof.

3. The method of claim 2, wherein the phthalate ester comprises monomethyl phthalate, monoethyl phthalate, monononyl phthalate, monododecyl phthalate, monoundecyl phthalate, dimethyl phthalate, diethyl phthalate, dinonyl phthalate, didodecyl phthalate, diundecyl phthalate, monophenyl phthalate, monobenzyl phthalate, diphenyl phthalate, dibenzyl phthalate, or a combination thereof.

4. The method of claim 1, wherein the composition further comprises a dispersant, wherein the dispersant is an amide, imide, ester, or acid reaction product of a succinic anhydride with a pendant hydrocarbon and an amine having at least one primary amine group, an alcohol, or water.

5. The method of claim 4, wherein the pendant hydrocarbon is selected from the group consisting of an alkyl group, an aryl group, an aryl alkyl group, an alkyl aryl group, an alkenyl group, an alkenyl aryl group, and an aryl alkenyl group comprising between about 6 and about 50 carbon atoms.

6. The method of claim 4, wherein the reaction product comprises a monoamide, a diamide, a triamide, an imide, an ester, or any combination thereof.

7. The method of claim 4, wherein the amide reaction product has a weight average molecular weight ranging from about 400 Da to about 2,000 Da.

8. The method of claim 4, wherein the composition comprises from about 1 wt. % to about 50 wt. % of the dispersant.

9. The method of claim 1, wherein the surfactant is an anionic surfactant.

10. The method of claim 1, wherein the composition is added to the medium continuously or intermittently.

11. The method of claim 1, wherein the composition is added before an inlet separator vessel, after an inlet separator vessel, before a condensate stabilizer unit, after a condensate stabilizer unit, before a condensate reboiler, or any combination thereof.

12. The method of claim 1, wherein the medium comprises a hydrocarbon condensate stream.

13. The method of claim 1, further comprising transporting the medium to a condensate stabilizer and heating the medium to between about 100° C. and 115° C.

14. The method of claim 1, wherein the composition comprises a boiling point greater than about 50° C.

15. The method of claim 1, wherein the inorganic particle comprises an iron sulfide, an iron carbonate, an iron oxide, or any combination thereof, and/or wherein the organic particle comprises an asphaltene, a coke solid, a gum or any combination thereof.

16. The method of claim 1, wherein the composition is added in an amount from about 1 ppm to 50,000 ppm.

17. The method of claim 1, further comprising adding the composition to the surface.

18. The method of claim 1, further comprising adding to composition into a condensate stream comprising the surface.

19. The method of claim 1, wherein the composition comprises from about 5 wt. % of the surfactant to about 100 wt. % of the surfactant.

20. The method of claim 1, wherein a reboiler comprises the surface.
